(19) United States
(12) Patent Application Publication
(10) Pub. No.: US 2009/0047559 A1
(43) Pub. Date: Feb. 19, 2009

(54) FUEL CELL ELECTRODE CATALYST WITH IMPROVED NOBLE METAL UTILIZATION EFFICIENCY, METHOD FOR MANUFACTURING THE SAME, AND SOLID POLYMER FUEL CELL COMPRISING THE SAME

(76) Inventors: Tomoaki Terada, Shizuoka (JP); Takahiro Nagata, Shizuoka (JP); Toshiharu Tabata, Shizuoka (JP); Susumu Enomoto, Shizuoka (JP); Hideyasu Kawai, Aichi (JP); Hiroaki Takahashi, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/282,574

(22) PCT Filed: Mar. 14, 2007
(86) PCT No.: PCT/JP2007/055780

§ 371 Date: Sep. 11, 2008

(30) Foreign Application Priority Data
Mar. 14, 2006 (JP) 2006-069723

(51) Int. Cl. H01M 4/92; H01M 4/88; B01J 23/42; B01J 21/18

(52) U.S. Cl. 429/27; 502/101; 502/339; 502/300; 502/182

(57) ABSTRACT

An object of the present invention is to further increase the rate of Pt particles (Pt utilization rate) for three-phase interfaces in order to reduce the amount of catalytic metal such as Pt used for fuel cells. The present invention provides a fuel cell electrode catalyst comprising a conductive carrier and catalytic metal particles, wherein an average particle size of the carried catalytic metal particles is larger than an average pore size of micropores in the conductive carrier.

### TECHNICAL FIELD

The present invention relates to a fuel cell electrode catalyst with an improved noble metal utilization efficiency, a method for manufacturing the fuel cell electrode catalyst, and a solid polymer fuel cell comprising the fuel cell electrode catalyst.

### BACKGROUND ART

Solid polymer fuel cells having polyelectrolyte membranes are expected to be used as power sources for vehicles such as electric cars and small cogeneration systems because of the easiness with which their sizes and weights can be reduced. However, the solid polymer fuel cell has a relatively low operating temperature, and its waste heat cannot be easily used as auxiliary driving power or the like. Accordingly, to be put to practical use, the solid polymer fuel cell needs to exhibit sufficient performance to offer a high generation efficiency and a high output density under operating conditions under which anode reaction gas (pure hydrogen) and cathode reaction gas (air or the like) are utilized efficiently.

An electrode reaction in each of the catalyst layers in the anode and cathode of a solid polymer fuel cell progresses at three-phase interfaces (hereinafter referred to as reaction sites) at which a reaction gas, a catalyst, and a fluorine-containing ion exchange resin (electrolyte) are all present. Thus, the reaction of the electrodes progresses only at the three-phase interfaces where gas (hydrogen or oxygen), proton (H⁺), and electron (e⁻), which are active substances, can be simultaneously transmitted or received.

An example of the electrode having the above function is a solid polymer electrolyte-catalyst composite electrode containing a solid polymer electrolyte, carbon particles, and a catalytic substance. For example, in this electrode, the catalyst-carrying carbon particles are mixed with the solid polymer electrolyte and the mixture is three-dimensionally distributed. A plurality of pores are formed inside the electrode. The carbon, a carrier for the catalyst, forms an electron transmitting channel. The solid electrolyte forms a proton transmitting channel. The pores form a supply and discharge channel for oxygen or hydrogen water that is those products. These three channels spread three-dimensionally in the electrode to form countless three-phase interfaces that allow the gas, proton (H⁺), and electron (e⁻) to be simultaneously transmitted and received. This provides sites for electrode reaction.

Thus, in the conventional solid polymer fuel cells, a catalyst such as a metal catalyst or a metal carrying catalyst (for example, metal carrying carbon comprising a carbon black carrier having a large specific surface area and carrying a metal catalyst such as platinum) is coated with the same fluorine-containing ion exchange resin as or a fluorine-containing ion exchange resin different from that contained in a polyelectrolyte membrane. The coated catalyst is used as a constituent material for the catalyst layer. Reaction sites in the catalyst layer are thus made three-dimensional to increase their number and to improve the utilization efficiency of expensive noble metal such as platinum which is catalytic metal.

The performance level of the metal carrying catalyst depends on the degree of dispersion of the active metal and increases consistently with the surface area given the same amount of metal carried. Such metal carrying catalysts are manufactured by impregnation or adsorption or by allowing carbons to carry metal colloids.

JP Patent Publication (Kokai) No. 2003-320249 A describes the following problems with conventional methods for manufacturing a metal carrying catalyst.

(1) With the impregnation, active metal is likely to aggregate and to have an increased particle size and a reduced surface area. This prevents the activity of the active metal from being sufficiently expressed.

(2) The adsorption involves a high-temperature heating treatment (250 to 300° C.) in an inactive atmosphere or reducing atmosphere. This makes the active metal likely to be sintered. Thus, as in the case of (1), the active metal has an increased particle size and fails to sufficiently express its own activity.

(3) With the method of allowing carbon to carry metal colloids, for example, platinum colloids are manufactured by adding hydrazine or thiosulfate to a water solution of platinum as a reducing agent. In this case, the high reducing power of the hydrazine and thiosulfate causes particles of platinum colloids to grow fast and to increase their particle size. Thus, as in the case of (1), the active metal has a reduced surface area and fails to sufficiently express its own activity. Moreover, the thiosulfate makes sulfur and sulfur compounds likely to remain, promoting the degradation of activity of the catalyst.

Thus, to reduce the size of particles of the active metal while increasing the degree of dispersion of the particles in order to provide a metal carrying catalyst that can express a high activity, JP Patent Publication (Kokai) No. 2003-320249 A manufactures a metal carrying catalyst as follows. Ketjen carbon, serving as a carrier, is added to a mixed solution of ion exchange water, serving as a solvent, and ethanol, serving as a reducing agent. The solution is dispersed and boiled to sufficiently remove dissolved oxygen. A dinitrodiamine platinum salt, which is a metal salt, is added to the solution, which is then thermally refluxed to allow the ketjen carbon to carry Pt colloids. The solution is further cooled to the room temperature and filtered, washed, and dried.

It has been known that heating is carried out in reducing the noble metal catalyst during catalyst production as in JP Patent Publication (Kokai) No. 2003-320249 A. However, the purpose of the heating is to reduce the size of noble metal particles to increase the active area of the noble metal surface.

Both conventional cathode and anode use an electrode catalyst comprising catalytic metal particulates of platinum or a platinum alloy highly dispersed and carried in a conductive carrier such as carbon black which has a large specific surface area. Highly dispersing and carrying the particulates of the catalytic metal increases the reactive area of the electrode and improves the catalytic activity.

However, with the surface of the catalyst covered with an electrolyte, when metal particulates are carried even in micropores in the carrier, the catalytic metal particulates in the micropores of the carbon particulates cannot contact the solid electrolytic membrane.

That is, the conventional catalyst is expected to have Pt particles in micropores of carbons. This catalyst mixed with an electrolytic polymer such as nafion prevents the polymer from entering the micropores. Thus, the Pt particles in the micropores do not contribute to three-phase interfaces, reducing the utilization rate of Pt.

### DISCLOSURE OF THE INVENTION

The present invention has been made in view of the problems of the conventional art. An object of the present invention is to further increase the rate of Pt particles (Pt utilization rate) for three-phase interfaces in order to reduce the amount of catalytic metal such as Pt used for fuel cells.

The present inventors have made the present invention by finding that the above problems can be solved by executing a particular treatment to prepare a catalyst.

First, the present invention provides a fuel cell electrode catalyst comprising a conductive carrier and catalytic metal particles, wherein an average particle size of the carried catalytic metal particles is larger than an average pore size of micropores in the conductive carrier. The term “micropores in the conductive carrier” as used herein refers to pores of pore size at most 2 nm which further branch from the pores in the conductive carrier.

The catalytic metal particles are prevented from entering the micropores in the conductive carrier by increasing the average size of the carried catalytic metal particles above that of the micropores in the conductive carrier. The catalytic metal is thus only present on the surface of the conductive carrier or at most in the pores. Further, particles of a polymer electrolyte with a size of several mm normally adhere to the conductive carrier. Thus, the conductive carrier, catalytic metal, and polymer electrolyte are only present on the surface of or at most in the pores in the conductive carrier to form three-phase interfaces. This enables a reduction of useless catalytic metal to enable the improvement of utilization efficiency of expensive Pt particles or the like.

The average particle size of the catalytic metal particles of the fuel cell electrode catalyst in accordance with the present invention is preferably at least 1.8 nm and at most 5 mm, more preferably at least 2 nm and at most 5 nm.

Any of a wide variety of well-known catalytic components of fuel cells may be used as the catalytic metal of the fuel cell electrode catalyst in accordance with the present invention. A preferred example is platinum. Further, any of a wide variety of well-known catalytic carriers of fuel cells may be used as the conductive carrier. A preferred example is any of various types of carbon powder or fibrous carbon materials.

Second, the present invention provides a method for manufacturing a fuel cell electrode catalyst comprising a conductive carrier and catalytic metal particles, the method comprising steps of mixing and stirring a catalytic metal salt solution and conductive carrier particles and then reducing the catalytic metal salt to allow the conductive carrier to carry the catalytic metal, wherein the catalytic metal salt solution and conductive carrier particles are poured in and then mixed and stirred while heating.

The present invention also provides a method for manufacturing a fuel cell electrode catalyst comprising a conductive carrier and catalytic metal particles, the method comprising steps of mixing and stirring a catalytic metal salt solution and conductive carrier particles and then reducing the catalytic metal salt to allow the conductive carrier to carry the catalytic metal, wherein after pouring in and heating the catalytic metal salt solution, the solution is mixed with the conductive carrier particles and stirred.

In the method for manufacturing a fuel cell electrode catalyst in accordance with the present invention, the heating is preferably carried out at 80 to 100° C. for 0.5 to 2 hours. The heating step adjusts the average particle size of catalytic metal particles to at least 1.8 nm, preferably at least 2 nm.

In the method for manufacturing a fuel cell electrode catalyst in accordance with the present invention, a preferred example of the catalytic metal is platinum, and a preferred example of the conductive carrier is carbon powder or a fibrous carbon material, as described above.

Third, the present invention provides a solid polymer fuel cell having an anode, a cathode, and a polyelectrolyte membrane located between the anode and the cathode, the fuel cell comprising the above fuel cell electrode catalyst as an electrode catalyst for the cathode and/or anode.

In spite of increasing the utilization efficiency of the noble metal and reducing useless noble metal, the electrode catalyst in accordance with the present invention enables the construction of a solid polymer fuel cell providing cell power in no way inferior to that in the conventional art.

According to the present invention, the heating step enables the average particle size of catalytic metal particles to be adjusted. Thus, the present invention provides the fuel cell electrode catalyst comprising the conductive carrier and catalytic metal particles, wherein the average particle size of the carried catalytic metal particles is larger than the average pore size of micropores in the conductive carrier. This makes it possible to further increase the rate of Pt particles (Pt utilization rate) for three-phase interfaces in order to reduce the amount of catalytic metal such as Pt used for fuel cells.

### BRIEF DESCRIPTION OF THE DRAWINGS

FIG. 1 is a schematic sectional view of a conventional fuel cell electrode catalyst;

FIG. 2 is a schematic sectional view of a fuel cell electrode catalyst in accordance with the present invention;

FIG. 3 is a diagram showing the flows of preparation of catalysts in Comparative Example and Examples 1 and 2; and

FIG. 4 is a graph showing voltage-current density curves for Comparative Example and Examples 1 and 2.

### BEST MODE FOR CARRYING OUT THE INVENTION

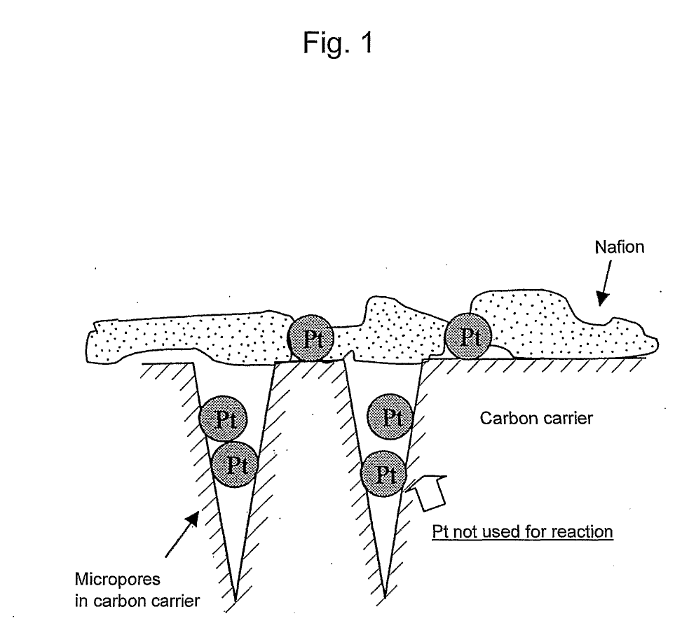

FIG. 1 shows a schematic sectional view of a conventional fuel cell electrode catalyst. As shown in FIG. 1, the conventional electrode catalyst includes a carbon carrier having micropores of pore size about several nm in which Pt particles of smaller particle size are expected to be present. The Pt catalyst mixed with a polymer electrolyte such as nation (trade name) prevents the polymer electrolyte from entering the micropores when the polymer electrolyte has a spread of about 4 nm. Consequently, the polymer electrolyte adheres to the surface of the micropores. This prevents the Pt particles in the micropores from contacting the solid electrolytic membrane; the Pt particles thus do not contribute to three-phase interfaces. This reduces the Pt utilization rate.

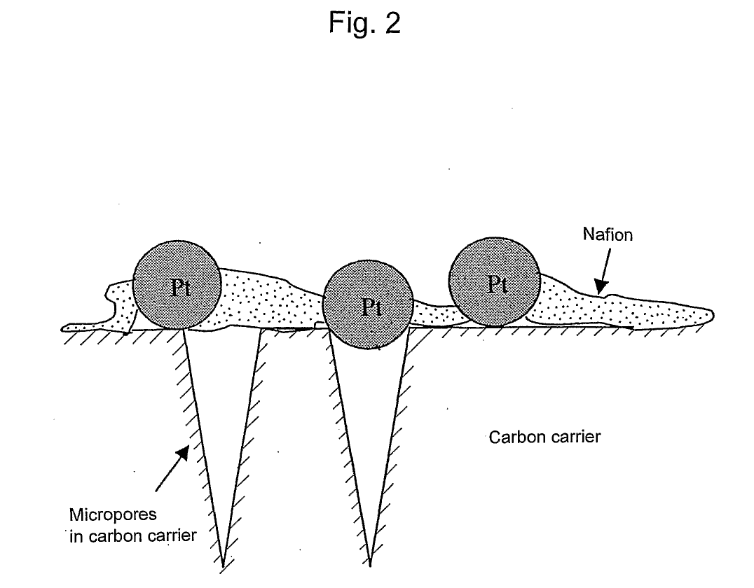

FIG. 2 shows a schematic sectional view of a fuel cell electrode catalyst in accordance with the present invention. As shown in FIG. 2, the catalytic metal particles are prevented from entering the micropores in the conductive carrier by increasing the average size of the carried catalytic metal particles above that of the micropores in the conductive carrier. The catalytic metal is thus only present on the surface of the conductive carrier or at most in the pores. Further, particles of the polymer electrolyte with a size of several nm normally adhere to the conductive carrier. Thus, the conductive carrier, catalytic metal, and polymer electrolyte are only present on the surface of or at most in the micropores in the conductive carrier to form three-phase interfaces. This enables a reduction of useless catalytic metal to enable the improvement of utilization efficiency of expensive Pt particles or the like.

A detailed description will be given of a cathode and a solid polymer fuel cell comprising the cathode in accordance with a preferred embodiment of the present invention.

The metal catalyst contained in the fuel cell electrode catalyst in accordance with the present invention is not particularly limited. However, platinum or a platinum alloy is preferred. Moreover, the metal catalyst is preferably carried in the conductive carrier. The conductive carrier is not particularly limited but is preferably a carbon material of specific surface area at least 200 m²/g. For example, carbon black or activated carbon is preferably used.

The polymer electrolyte contained in the fuel cell electrode catalyst in accordance with the present invention is preferably a fluorine-containing ion exchange resin, particularly preferably a sulfonic-acid-type perfluorocarbon polymer. The sulfonic-acid-type perfluorocarbon polymer is chemically stable in a cathode for a long time and enables fast proton transmission.

The thickness of a catalyst layer in the fuel cell electrode catalyst in accordance with the present invention has only to be equivalent to that in normal gas diffusion electrodes and is preferably 1 to 100 μm, more preferably 3 to 50 μm.

In the solid polymer fuel cell, an overvoltage resulting from an oxygen reducing reaction of the cathode is very high compared to that resulting from a hydrogen oxidizing reaction of an anode. Accordingly, effectively utilizing reaction sites to improve the electrode characteristics of the cathode is effective in enhancing the output characteristics of the cell. On the other hand, the configuration of the anode is not particularly limited; the anode may be configured like a well-known gas diffusion electrode, for example.

A polyelectrolyte membrane used in the solid polymer fuel cell in accordance with the present invention is not particularly limited and may be any ion exchange membrane exhibiting a high ion conductivity in a wet condition. A solid polymer material constituting the polyelectrolyte membrane may be, for example, a perfluorocarbon polymer having a sulfonic group, a polysulfonic resin, a perfluorocarbon polymer having a phosphonic group, or a carboxylic group, or the like. In particular, the sulfonic-acid-type perfluorocarbon polymer is preferred. This polyelectrolyte membrane may be composed of fluorine-containing ion exchange resin, contained in the catalyst layer, or a resin different from the catalyst layer.

The fuel cell electrode catalyst in accordance with the present invention may be produced by using a conductive carrier carrying a metal catalyst and a coating liquid obtained by dissolving or dispersing the polyelectrolyte in a solvent or a dispersing medium. Alternatively, the fuel cell electrode catalyst in accordance with the present invention may be produced by using a coating liquid obtained by dissolving or dispersing a catalyst-carrying conductive carrier and the polyelectrolyte in a solvent or a dispersing medium. The solvent or dispersing medium may be, for example, alcohol, fluorine-containing alcohol, or fluorine-containing ether. Then, the coating liquid is coated on a carbon cloth or the like which constitutes an ion exchange membrane or a gas diffusion layer to form a catalyst layer. Alternatively, a catalyst layer may be formed on the ion exchange membrane by coating the coating liquid on a separate base to form a coating layer and transferring the coating layer to the ion exchange membrane.

If the fuel cell electrode catalyst layer is formed on the gas diffusion layer, the catalyst layer and the ion exchange membrane are preferably joined together by adhesion or hot pressing. Further, if the catalyst layer is formed on the ion exchange layer, the cathode may be composed only of the catalyst layer or of the catalyst layer and the adjacent gas diffusion layer.

A separator having a gas channel formed therein is normally placed outside the cathode. The channel is supplied with gas containing hydrogen for the anode and gas containing oxygen for the cathode. The solid polymer fuel cell is configured as described above.

### EXAMPLES

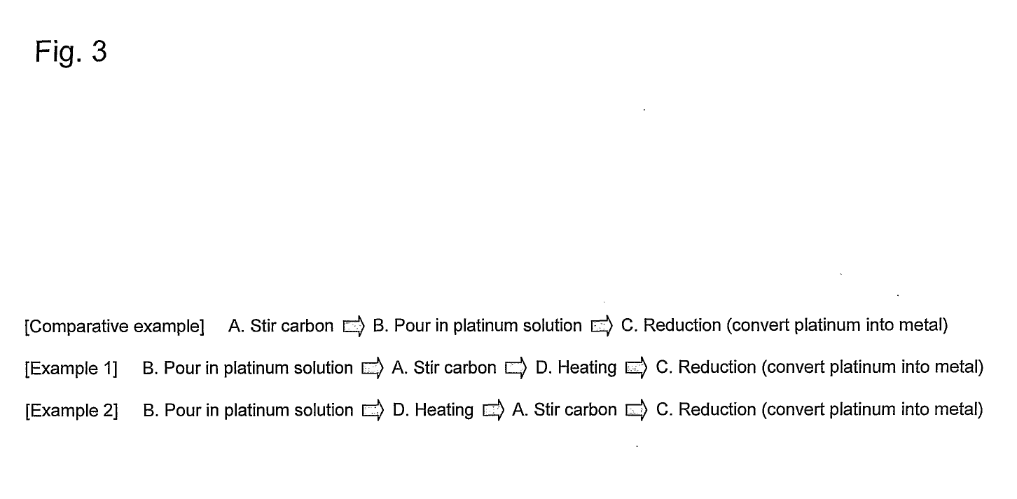

The cathode and solid polymer fuel cell in accordance with the present invention will be described below in detail with reference to examples and a comparative example. FIG. 3 shows the flow of preparation of each catalyst.

### Comparative Example

First, 4.71 g of commercially available carbon powder with a large specific surface area was added to and dispersed in 0.5 L of pure water. A hexahydroso platinum nitric acid solution containing 4.71 g of platinum was dropped to the fluid dispersion and made to sufficiently blend in to the carbon. About 5 mL of 0.01 N ammonia was added to the solution to set pH to about 9 to form a platinum hydroxide, which was precipitated in the carbon. The fluid dispersion was then washed and a powder obtained was dried in a vacuum at 100° C. for 10 hours. Then, the powder was held in hydrogen gas at 500° C. for 2 hours for a reduction treatment. The powder was then washed in pure water. The filtered and washed powder was dried in a vacuum at 100° C. for 10 hours. A platinum-carrying carbon catalyst powder A obtained had a platinum carrying density of 50%. Further, CO pulse measurements were made to determine the average platinum particle size to be about 1.5 nm. The physical properties of the catalyst powder A obtained are shown in Table 1, shown below.

### Example 1

A hexahydroso platinum nitric acid solution containing 4.71 g of platinum was dropped to 0.5 L of pure water. About 5 mL of 0.01 N ammonia was added to the solution to set pH to about 9 to form a platinum hydroxide. Then, 4.71 g of commercially available carbon powder with a large specific surface area was poured in. The fluid dispersion was heated to 90° C. and stirred for 1 hour. The fluid dispersion was cooled down to the room temperature and then washed to obtain a powder. The powder obtained was dried in a vacuum at 100° C. for 10 hours. Then, the powder was held in hydrogen gas at 500° C. for 2 hours for a reduction treatment. The powder was washed in pure water. Then the powder was filtered and washed, and dried in a vacuum at 100° C. for 10 hours. A platinum-carrying carbon catalyst powder B obtained had a platinum carrying density of 50%. Further, CO pulse measurements were made to determine the average platinum particle size to be about 2.0 nm n. The physical properties of the catalyst powder B obtained are shown in Table 1, shown below.

### Example 2

A hexahydroso platinum nitric acid solution containing 4.71 g of platinum was dropped to 0.5 L of pure water. About 5 mL of 0.01 N ammonia was added to the solution to set pH to about 9 to form a platinum hydroxide. Then, this fluid dispersion was heated to 90° C., and 4.71 g of commercially available carbon powder with a large specific surface area was poured in. The fluid dispersion was stirred for 1 hour. The fluid dispersion was cooled down to the room temperature and then washed to obtain a powder. The powder obtained was dried in a vacuum at 100° C. for 10 hours. Then, the powder was held in hydrogen gas at 500° C. for 2 hours for a reduction treatment. The powder was washed in pure water. Then the powder was filtered and washed, and dried in a vacuum at 100° C. for 10 hours. A platinum-carrying carbon catalyst powder C obtained had a platinum carrying density of 50%. Further, CO pulse measurements were made to determine the average platinum particle size to be about 2.0 nm. The physical properties of the catalyst powder C obtained are shown in Table 1, shown below.

TABLE 1

| | | | Average platinum |
|---|---|---|---|
| | | | particle size (nm) |
| | | Platinum carrying | CO pulse |
| | Sample | density (%) | measurements |
| Comparative | Catalyst powder A | 50 | 1.5 |
| example | | | |
| Example 1 | Catalyst powder B | 50 | 2.0 |
| Example 2 | Catalyst powder C | 50 | 2.0 |

Table 1 shows that the platinum carrying density was 50% in all of Comparative Example and Examples 1 and 2 but that the average platinum particle size of Examples 1 and 2 determined by the CO pulse measurements was about 2.0 nm, indicating the significant adjustment of the particle size.

### [Performance Evaluations]

The platinum-carrying carbon catalyst powders A to C obtained were used to form single cell electrodes for solid polymer fuel cells as described below. Each of the platinum-carrying carbon catalyst powders A to C was dispersed in an organic solvent together with nation (trade mark). A Teflon (trade mark) sheet was coated with the resulting fluid dispersion to form a catalyst layer. The amount of Pt catalyst per electrode area was 0.30 mg/cm² in the carbon catalyst powder A, 0.25 mg/cm² in the carbon catalyst powder B, and 0.24 mg/cm² in the carbon catalyst powder C. Electrodes formed of the platinum-carrying carbon catalyst powders A to C were laminated together via polyelectrolyte membranes by hot pressing respectively. Diffusion layers were installed on the opposite sides of the laminated electrodes to form a single cell electrode.

### [MEA Performance Evaluations]

The single cell was subjected to generation evaluation tests under the following conditions.

| | |
|---|---|
| “Cathode electrode membrane thickness”: | 6 mil |
| “Gas flow rate” | anode: H₂ 500 cc/min |
| | cathode: air 1,000 cc/min |
| “Humidifying temperature” | anode bubbling: 70° C. |
| | cathode bubbling: 80° C. |
| “Pressure” | anode: 0.2 MPa |
| | cathode: 0.2 MPa |
| “Cell temperature”: | 80° C. |

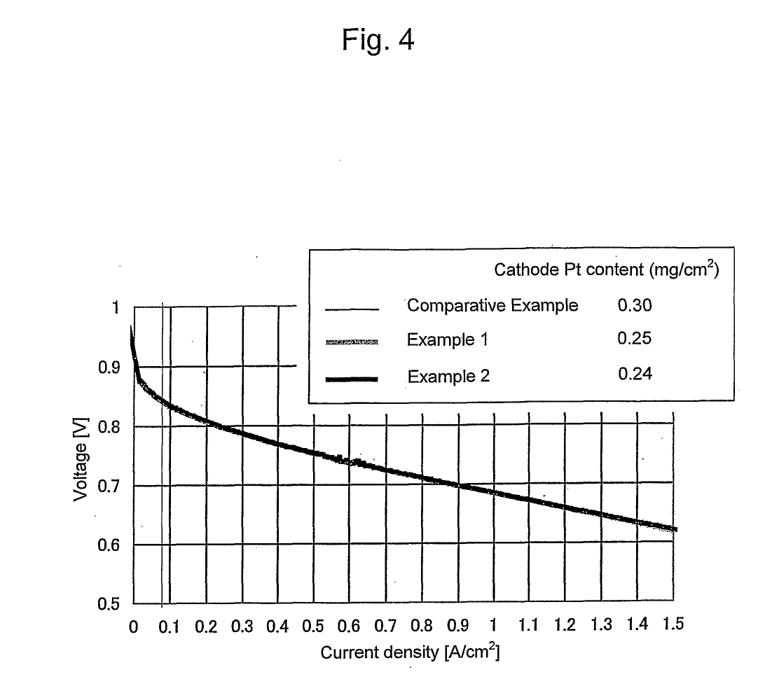

Under the above conditions, current density and cell voltage were measured to obtain I-V evaluations shown in FIG. 4. The figure shows that in spite of their cathode Pt contents smaller than that in Comparative Example, Examples 1 and 2 exhibited generation performance in no way inferior to that of Comparative Example.

### [Pt Utilization Rate Evaluations]

The single cell was subjected to generation evaluation tests under the following conditions.

| | |
|---|---|
| “Cathode electrode membrane thickness”: | 6 mil |
| “Gas flow rate” | anode: H₂ 500 cc/min |
| | cathode: N₂ 1,000 cc/min |
| “Humidifying temperature” | anode bubbling: 70° C. |
| | cathode bubbling: 80° C. |
| “Pressure” | anode: 0.2 MPa |
| | cathode: 0.2 MPa |
| “Cell temperature”: | 80° C. |

Under the above conditions, CV (Cyclic Voltammetry) was carried out to measure H₂ desorption peaks. The Pt utilization rates shown in Table 2, shown below, were calculated.

Pt utilization rate (%)=[electrochemically effective Pt surface area (calculated on the basis of H₂ desorption peaks)]/[geometric Pt surface area (calculated on the basis of Pt particle size@CO pulses)]×100

TABLE 2

| | | Pt Utilization Rate |
|---|---|---|
| | Sample | (%) |
| Comparative | Catalyst Powder A | 24 |
| Example | | |
| Example 1 | Catalyst Powder B | 27 |
| Example 2 | Catalyst Powder C | 30 |

Table 2 indicates that Examples 1 and 2 of the present invention exhibited higher Pt utilization rates compared to Comparative Example.

### INDUSTRIAL APPLICABILITY

According to the present invention, the heating step has enabled the average particle size of catalytic metal particles to be adjusted. Thus, the present invention has provided the fuel cell electrode catalyst comprising the conductive carrier and catalytic metal particles, wherein the average particle size of the carried catalytic metal particles is larger than the average pore size of the micropores in the conductive carrier. This has made it possible to further increase the rate of Pt particles (Pt utilization rate) for three-phase interfaces in order to reduce the amount of catalytic metal such as Pt used for fuel cells. The fuel cell electrode catalyst in accordance with the present invention contributes to practical application and prevalence of fuel cells.

1. A fuel cell electrode catalyst comprising a conductive carrier and catalytic metal particles, characterized in that an average particle size of the carried catalytic metal particles is larger than an average pore size of micropores in the conductive carrier.

2. The fuel cell electrode catalyst according to claim 1, characterized in that the average particle size of the catalytic metal particles is at least 1.8 nm.

3. The fuel cell electrode catalyst according to claim 1 or 2, characterized in that the catalytic metal is platinum.

4. The fuel cell electrode catalyst according to any of claims 1 to 3, characterized in that the conductive carrier is carbon powder or a fibrous carbon material.

5. A method for manufacturing a fuel cell electrode catalyst comprising a conductive carrier and catalytic metal particles, characterized by comprising steps of mixing and stirring a catalytic metal salt solution and conductive carrier particles and then reducing the catalytic metal salt to allow the conductive carrier to carry the catalytic metal and in that the catalytic metal salt solution and conductive carrier particles are poured in and then mixed and stirred under heat.

6. A method for manufacturing a fuel cell electrode catalyst comprising a conductive carrier and catalytic metal particles, characterized by comprising steps of mixing and stirring a catalytic metal salt solution and conductive carrier particles and then reducing the catalytic metal salt to allow the conductive carrier to carry the catalytic metal and in that after pouring in and heating the catalytic metal salt solution, the solution is mixed with the conductive carrier particles and stirred.

7. The method for manufacturing a fuel cell electrode catalyst according to claim 5 or 6, characterized in that the heating is carried out at 80 to 100° C. for 0.5 to 2 hours.

8. The method for manufacturing a fuel cell electrode catalyst according to any of claims 5 to 7, characterized in that the heating adjusts an average particle of the catalytic metal particles to at least 1.8 nm.

9. The method for manufacturing a fuel cell electrode catalyst according to any of claims 5 to 8, characterized in that the catalytic metal is platinum.

10. The method for manufacturing a fuel cell electrode catalyst according to any of claims 5 to 9, characterized in that the conductive carrier is carbon powder or a fibrous carbon material.

11. A solid polymer fuel cell having an anode, a cathode, and a polyelectrolyte membrane located between the anode and the cathode, characterized by comprising the fuel cell electrode catalyst according to any of claims 1 to 4 as an electrode catalyst for the cathode and/or anode.
